(19) United States
(12) Patent Application Publication
(10) Pub. No.: US 2018/0060870 A1
(43) Pub. Date: Mar. 1, 2018

(54) MULTILEVEL MARKETING SYSTEM AND METHOD

(71) Applicant: "Session" Limited Liability Company, Moscow (RU)

(72) Inventors: Narek Sirakanyan, Moscow (RU); Evgeny Bogdanchikov, Moscow (RU)

(73) Assignee: "Session" Limited Liability Company, Moscow (RU)

(21) Appl. No.: 15/691,322

(22) Filed: Aug. 30, 2017

Related U.S. Application Data
(60) Provisional application No. 62/382,016, filed on Aug. 31, 2016.

(51) Int. Cl. G06Q 30/00; H04L 29/08; H04M 3/51; H04M 1/725; G06Q 40/06; G06Q 10/06; G06Q 30/06; G06Q 10/10

(52) U.S. Cl. CPC G06Q 30/01; H04L 67/20; H04L 67/04; H04M 3/5158; H04M 1/72525; G06Q 40/025; G06Q 10/06398; G06Q 30/0611; G06Q 10/1097; H04M 2203/405; H04M 2203/306; G06Q 40/06

(57) ABSTRACT

A system and method for managing a hierarchy of a plurality of distributors over a computer network is disclosed. In one aspect the system includes a server in communication with at least one third party marketing server and at least one distributor database; and a plurality of distributor devices communicating over the computer network with the server, the plurality of distributor devices each operating a distributor mobile application, the distributor mobile application configured to determine a business value for each of the plurality of distributors based on the business information provided by the at least one third party marketing server, wherein the business value is updated on the at least one distributor database via the server over the computer network. The system allows for investment in the plurality of distributors by investors.

### CROSS REFERENCE TO RELATED APPLICATIONS

The present U.S. patent application claims priority benefit of U.S. Provisional Patent Application No. 62/382,016, filed on Aug. 31, 2016, the entire content of which is incorporated herein by reference.

### FIELD

The Applicant's teachings relate to the field of e-commerce. Specifically, the present invention pertains to multi-level marketing systems using networks such as the Internet and mobile networks.

### INTRODUCTION

In current multi-level marketing (MLM) mobile applications, method of set up and input is manual. Assignment of tasks within MLM mobile applications is also manual. There is a need for automated registration and assignment of tasks.

In every MLM company, generating new leads and keeping them warm is essential but costly. Thus, there is a need to provide for investment into generating new leads, allowing distributors themselves to pay for these leads or allowing outside investors to fund the generation of these leads.

Moreover, there is a need for linking the MLM system to banking. Currently, it is difficult for a distributor in an MLM system to have their business venture reflected in their credit rating.

It is therefore an object of the present teachings to provide an automated MLM system and method that is implemented through mobile devices. It is also an object of the present teachings to provide a system and method to allow investment within the system.

### SUMMARY

In accordance with an aspect of the Applicant's teachings, there is provided a system for managing a hierarchy of a plurality of distributors over a computer network, the system comprising: a server in communication with at least one third party marketing server and at least one distributor database; and a plurality of distributor devices communicating over the computer network with the server, the plurality of distributor devices each operating a distributor mobile application, the distributor mobile application configured to determine a business value for each of the plurality of distributors based on the business information provided by the at least one third party marketing server, wherein the business value is updated on the at least one distributor database via the server over the computer network.

In an embodiment, the system for managing a hierarchy of a plurality of distributors over a computer network further comprises an investor database storing investor information related to at least one investor and a plurality of funds based on the hierarchy of the plurality of distributors; and at least one investor device communicating over the computer network with the server, the at least one investor devices operating an investor mobile application, the investor mobile application configured to present the plurality of funds from which an investor selects to purchase, wherein the server updates the investor information and the plurality of funds based on the investor purchase.

In another embodiment, the distributor mobile application is further configured to determine a ranking for each of the plurality of distributors, each ranking determined based on tasks performed by each distributor through the distributor mobile application.

In another embodiment, tasks are selected from the group consisting of phoning a contact, watching a seminar, reviewing recordings of phone calls, and buying new leads.

In another embodiment, the business information comprises discounted cash flow models, business structure analysis, projected cash flow and discounts.

In another embodiment, the ranking is utilized to determine business value.

In another embodiment, the ranking is used to determine a credit rating to be utilized by a banking institution.

In another aspect of the Applicant's teachings, there is provided a method of routing a phone call to a lead in a sales network, the method comprising: acquiring a lead phone number associated with the lead; initiating a phone call to the lead using the lead phone number, the call initiated by a sales network server; auctioning the phone call to a plurality of distributors over the sales network, wherein the plurality of distributors place bids to win the phone call; determining a first winning bid by a first winning distributor from the plurality of bids by the plurality of distributors; and connecting the phone call between the lead and the first winning distributor, wherein the sales network server calls the first winning distributor to connect the phone call with the lead.

In an embodiment, the method of routing a phone call to a lead in a sales network further comprises: determining whether the phone call has been answered by the first winning distributor; when it is determined that the phone call is unanswered by the first winning distributor, determining a second winning bid by a second winning distributor from the plurality of bids by the plurality of distributors; and connecting the phone call between the lead and the second winning distributor.

In a further aspect of the Applicant's teachings, there is provided a method of scheduling communication between a distributor and at least one contact on a distributor mobile application on a distributor device connected to a sales network, the method comprising: prompting the distributor to select at least one contact through the distributor mobile application; prompting the distributor to enter relevant details about the at least one contact through the distributor mobile application; upon receiving the relevant details about the at least one contact, initiating a first phone call via the sales network to the at least one contact; upon the at least one contact answering the first phone call, playing a recording to the at least one contact; determining whether the at least one contact remains on the first phone call after a predetermined amount of time; upon determining that the at least one contact remains on the first phone call after a predetermined amount of time, initiating a second phone call via the server and the distributor device; and upon the distributor answering the second phone call, connecting the first phone call with the second phone call.

In an embodiment, the method of scheduling communication between a distributor and at least one contact on a distributor mobile application on a distributor device connected to a sales network further comprises prompting the distributor to fill out a questionnaire based on the communication between the contact and the distributor.

In another embodiment, after the step of determining whether the at least one contact remains on the first phone call, upon determining that the at least one contact does not remain on the phone call, terminating the first phone call and placing the at least one contact into a call back list.

In another embodiment, after terminating the first phone call, initiating a third phone call with a new at least one contact.

In another embodiment, the predetermined amount of time is about 10 seconds.

In another embodiment, the predetermined amount of time is about 30 seconds.

In another embodiment of the Applicant's teachings, the server initiates the first and second phone calls through a private branch exchange.

In yet another aspect of the Applicant's teachings, there is provided a method of initializing a distributor to utilize a distributor mobile application with a sales server over a computer network, the method comprising steps of: registering the distributor mobile application on the sales server, the sales server automatically requesting distributor information from a third party server to register the distributor; determining a business value for the distributor based on the requested distributor information; determining a ranking for the distributor based on the requested distributor information and a record of completed tasks by the distributor; scheduling tasks to be performed by the distributor at a predetermined time, the scheduled tasks assessed by the distributor mobile application for completion; upon completion of the scheduled tasks, determining a new business value and a new ranking; and updating a database in communication with the server with the new business value and the new ranking.

In an embodiment of the Applicant's teachings, tasks are selected from the group consisting of phoning a contact, watching a seminar, reviewing recordings of phone calls, and buying new leads.

In a still further aspect of the Applicant's teachings, there is provided a method of providing investment by an investor to a plurality of distributors, the method comprising: presenting a plurality of funds to the investor on an investor mobile application on an investor device, the plurality of funds each representing a plurality of distributors; prompting the investor to select one of the plurality of funds for purchase; upon selecting one of the plurality of funds, transferring a monetary value based on the purchase to the plurality of distributors as an investment; and displaying and returning results of the investment on the investor device through the investor mobile application.

These and other features of the Applicant's teachings are set forth herein.

### BRIEF DESCRIPTION OF THE DRAWINGS

The skilled person in the art will understand that the drawings, described below, are for illustration purposes only. The drawings are not intended to limit the scope of the Applicant's teachings in any way.

FIG. 1 is a block diagram that schematically illustrates a high-level architecture of a MLM system in accordance with various aspects of the Applicant's teachings.

FIG. 2 is a block diagram that schematically illustrates the architecture of the distributor mobile application on the distributor device of FIG. 1.

FIG. 3 is a block diagram that schematically illustrates the architecture of the investor mobile application on the investor device of FIG. 1.

FIG. 4 is a flow diagram illustrating the process for a distributor to access and utilize the MLM system using the distributor mobile application.

FIG. 5 is a flow diagram illustrating the process for assigning a task to a distributor in the MLM system of FIG. 1.

FIG. 6 is a flow diagram illustrating the process for recruiting leads for a distributor in the MLM system of FIG. 1.

FIG. 7 is a flow diagram illustrating the process for an investor to access the MLM system using the investor mobile application.

FIGS. 8 to 17 are various screenshots from an exemplary distributor mobile application.

In the drawings, like reference numerals indicate like parts.

### DESCRIPTION OF VARIOUS EMBODIMENTS

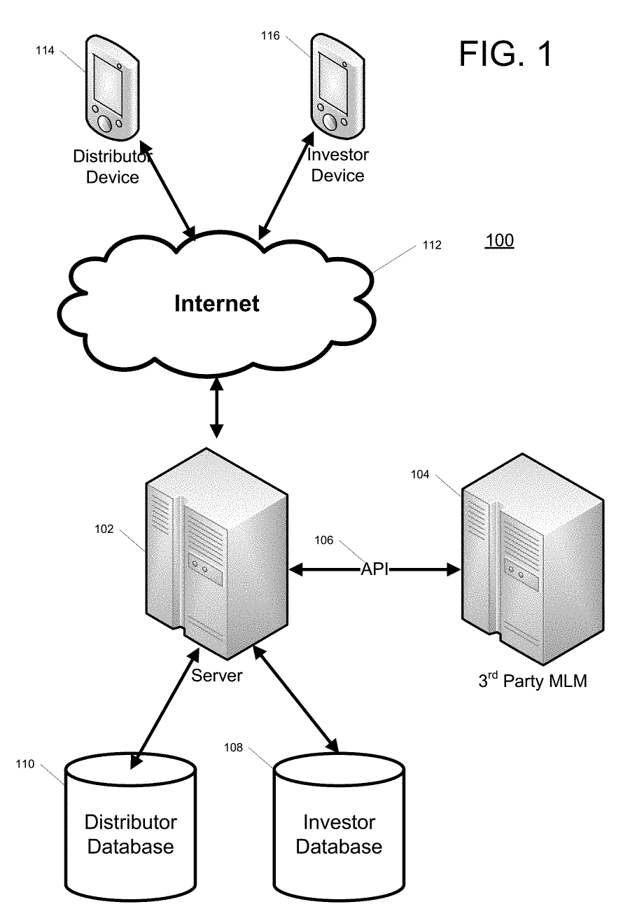

Reference is first made to FIG. 1 which schematically illustrates a MLM system and is generally referenced by the numeral 100. The MLM system 100 in this example having a server 102 and a distributor database 110 and an investor database 108. The MLM server 102 connects to existing third party MLM 104 via an application program interface (API) 106. The MLM system 100 includes a plurality of distributor user devices 114, such as smartphones, which connect to the server 102 via a network 112, such as the Internet. The distributor user devices 114 are configured to execute an application to access the distributor database 110 and the existing third party MLM 104 via the server 102. The MLM system 100 also includes a plurality of investor user devices 116 which connect to the server 102 via a network 112. The investor user devices 116 may include mobile devices such as smartphones which are configured to execute an application to access the investor database 108 through the server 102. While only a single server is shown in FIG. 1, MLM system 100 may include one or more servers and a plurality of databases in various embodiments. Similarly, while FIG. 1 only shows the server 102 connected to one third party MLM 104, the server 102 may be connected to a plurality of third party MLMs.

The databases 108 and 110 are configured to store data associated with the MLM system. Information the distributor database 110 may store may include, but is not limited to, distributor profile data, distributor hierarchy data, distributor ranking data, recordings of distributor phone calls, educational distributor seminars, etc. Investor database 108 may store investor profile data, investor portfolio data, past investments, investment results etc.

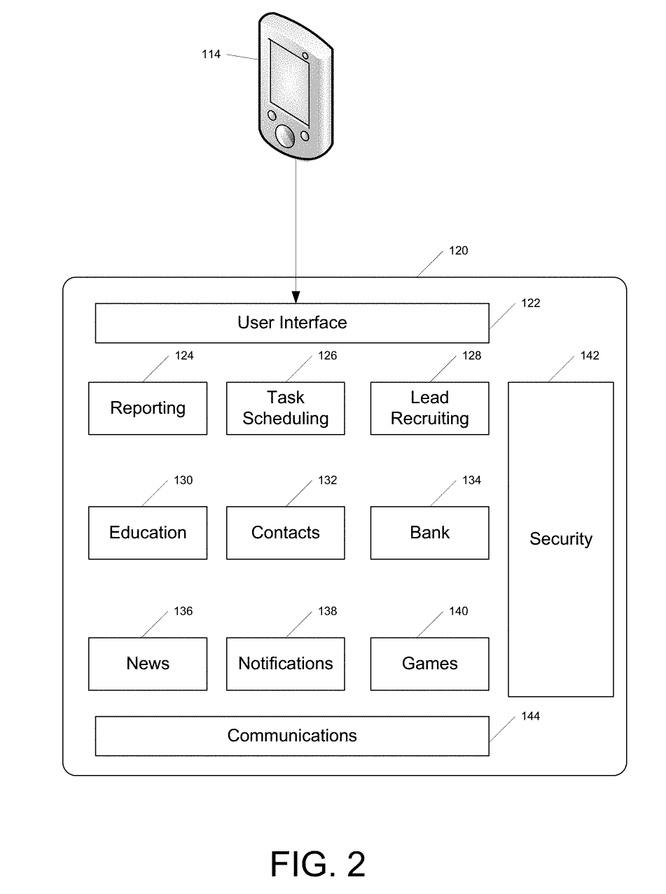

FIG. 2 is a block diagram schematically illustrating an embodiment of the distributor mobile application (or distributor app) 120 on a distributor user device 114. The distributor app 120 may include a user interface 122 for presenting the various modules of the distributor app 120 to the distributor. The distributor app 120 may include a reporting module 124, a task scheduling module 126, a lead recruiting module 128, an education module 130, a contacts module 132, a banking module 134, a newsfeed module 136, a notifications module 138, and a games module 140. The distributor app 120 may also include security protocol 142 and communications interface 144. The distributor app may also include a store with an electronic payment system and a shipping and tracking system. In another embodiment, the distributor app may include a tax preparation module for filling out necessary tax returns, preferably for an extra fee. The distributor app 120 may not have all of the elements or features listed and/or may have other elements or features instead of, or in addition to, those listed.

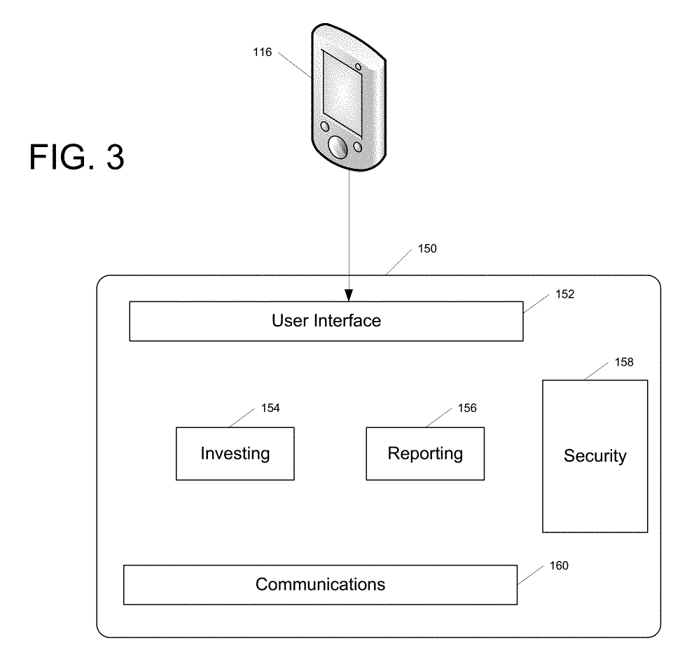

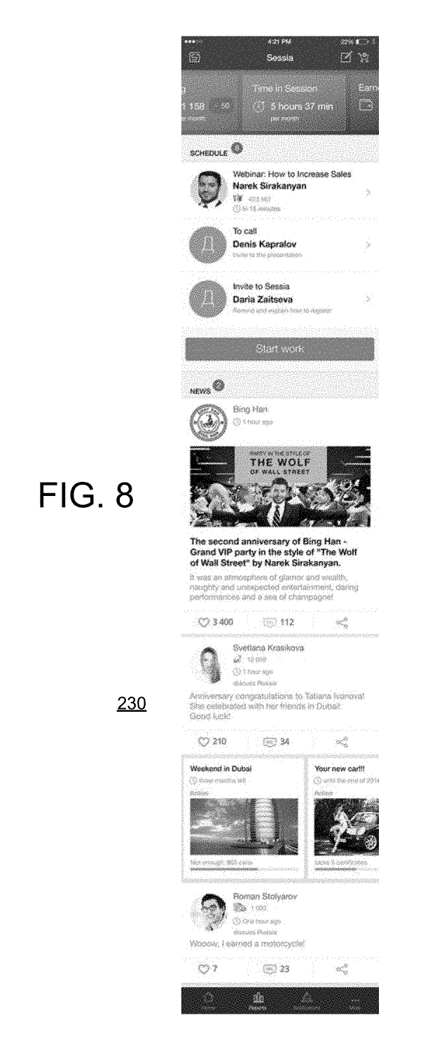

FIG. 3 is a block diagram schematically illustrating the investor mobile application (or investor app) 150 on an investor user device 112. The investor app 150 may include a user interface 152 for presenting various modules of the investor app 150 to the investor on the investor user device 112. The investor app 150 may include an investing module 154 and an investor reporting module 156. The investor app 150 may also include security protocol 158 and communications interface 160. The investor app 150 may not have all of the elements or features listed and/or may have other elements or features instead of, or in addition to, those listed. Distributor information relevant to the distributor app 120 may be stored in the distributor database 110. FIG. 8 shows a screenshot of an opening screen 230 for an exemplary distributor app.

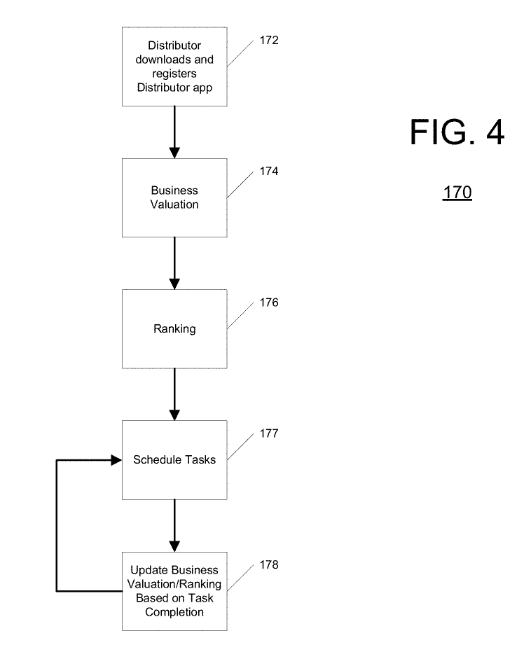

FIG. 4 is a flow diagram outlining the steps taken for a distributor to start using the MLM system 100 of FIG. 1. The process is generally referenced by the number 170. In step 172, the distributor downloads and installs the distributor app 120 to the distributor device 114. The distributor app 120 may be downloaded from any mobile app store including, but not limited to, the Apple App store, the Android Play store, the BlackBerry World, etc.

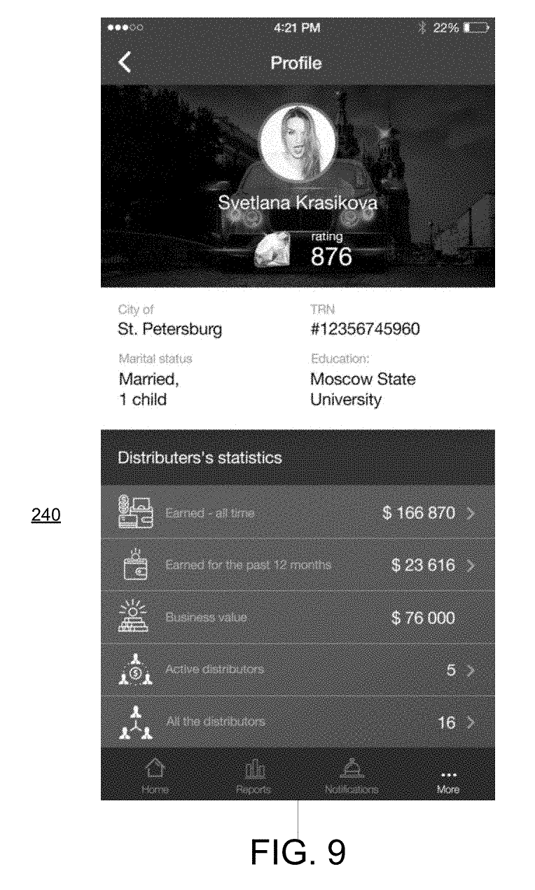

After installing the distributor app 120, the distributor is prompted to register with the MLM system 100. During registration with the MLM system 100, the distributor may be asked to supply standard profile information as well as information regarding their financial goals. In another embodiment, the distributor may be prompted to select the third party MLM the distributor subscribes to and provide credentials to be verified by the third party MLM 104. The system 100 then communicates with third party MLM 104 to verify that the distributor is a member, what level the distributor is at within the MLM, and acquires the distributor's full profile from the third party software. The distributor app 120 automatically builds the distributor profile accordingly. FIG. 9 shows a screenshot of the distributor profile screen 240 for an exemplary distributor app.

In another embodiment, the distributor may register through a QR code. In this embodiment, the third party MLM 104 generates a code for the distributor which is converted by the MLM server 102 to a QR code through which the new distributor would automatically be registered with the MLM system 100.

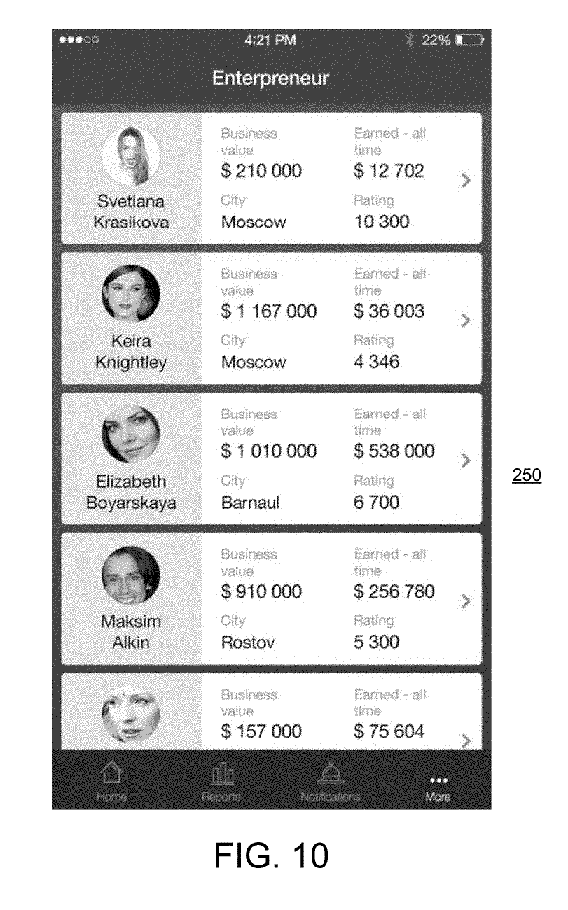

Once the distributor is registered, the distributor app 120 automatically assesses the distributor's business value and is calculated in step 174. Via the reporting module 124, the information obtained during registration in step 172 is evaluated. In one embodiment, discounted cash flow models, analysis of the business structure, projected cash flow and discounts, which are calculated from information supplied by the third party MLM, are used to build a football field valuation to determine the business value of the distributor. At a certain range, the middle point is provided and this middle point is the business value. The range is chosen in terms of standard deviation which is based on the percentage of available information from the third party MLM. The less information provided by the third party MLM, the larger the range. This business value is only calculated once the distributor generates reliable cash flows. Therefore, for an established distributor, this business value will appear automatically upon registration with the MLM system 100. For a first-time distributor, this value will not appear until the distributor has performed enough to have a consistent cash flow. The business value is updated in real-time whenever there is a change in the distributor's cash flow or distributor rating, which will be describe below. FIG. 10 shows a screenshot of the business valuation screen 250 provided by the reporting module 124 for an exemplary distributor app.

Once the business value is determined, the distributor app 120 automatically ranks the distributor in a global ranking system in step 176. The reporting module 124 provides a real-time global ranking system. As existing third party MLMs sign onto the MLM system 100, the MLM system 100 obtains information on all distributors within these individual third party MLMs, providing the basis for a global ranking system. The reporting module 124 may base an individual distributor's ranking on the distributor's earnings, achievements within the MLM system 100, and accomplishments of various tasks within the MLM system 100. In an alternate embodiment, the distributor app 120 may have a games module 140 which presents a video game that when successfully played, modifies the distributor's ranking. The video game may be supplied by the MLM server 102 or by the third party MLM 104. As soon as a distributor registers the distributor app, they receive a ranking since registering provides points that go towards modifying the distributor's ranking. Each time a distributor's ranking is modified, the distributor's business value also changes since ranking would be a consideration in the business value. In the reporting module 124, a higher distributor ranking translates to the distributor having more stable cash flows, and will use a lower discount rate to discount the higher ranking distributor's cash flows. The reporting module may base the ranking on other events, elements or features instead of, or in addition to, those listed.

An example of a task that may affect a distributor's ranking is the completion of a task such as viewing a seminar through the education module 130 of the MLM system 100. As the distributor views topical seminars via the education module 130, chosen for the distributor by the education module 130 based on the distributor's performance, the distributor's ranking is modified. After successful completion of a test about the seminar, the distributor's ranking is modified again. Another example of an action that can modify a distributor's ranking are winning contests through the third party MLM. A further example of an action that can modify a distributor's ranking are performing tasks that are scheduled by the MLM system 100 in a timely manner, which will be described in more detail below. The ranking may be based on other actions or features instead of, or in addition to, those listed above.

Another example of an action that can modify a distributor's ranking is assigning tasks to downline distributors. An upline distributor or sponsor recruits new distributors and shares in a percentage of these new distributors or downline distributors. An upline distributor having at least one downline distributor may assign a task to the at least one downline distributor. These tasks may be preset by the task scheduling module 126 that the upline distributor chooses from or the upline distributor may be able to create unique challenges. The task scheduling module 126 on the downline distributor app is notified and the downline distributor may accept or reject the challenge. A downline distributor is given a time frame in which to accept or reject the challenge. A rejected challenge or expired challenge may result in a reduction in the ranking for both the upline and downline distributors. An accepted challenge that is completed by the downline distributor may result in an increase in the ranking of both the upline and downline distributors. Some examples of challenges which may be issued by an upline distributor may include, but are not limited to, registering a certain number of contacts or leads in a certain amount of time, increasing the downline distributor ranking within a certain amount of time, finish viewing a certain number of seminars within a certain amount of time with a successful completion. In one embodiment, challenges issued by upline distributors to downline distributors may appear on the timeline of the newsfeed of the upline and/or downline distributors.

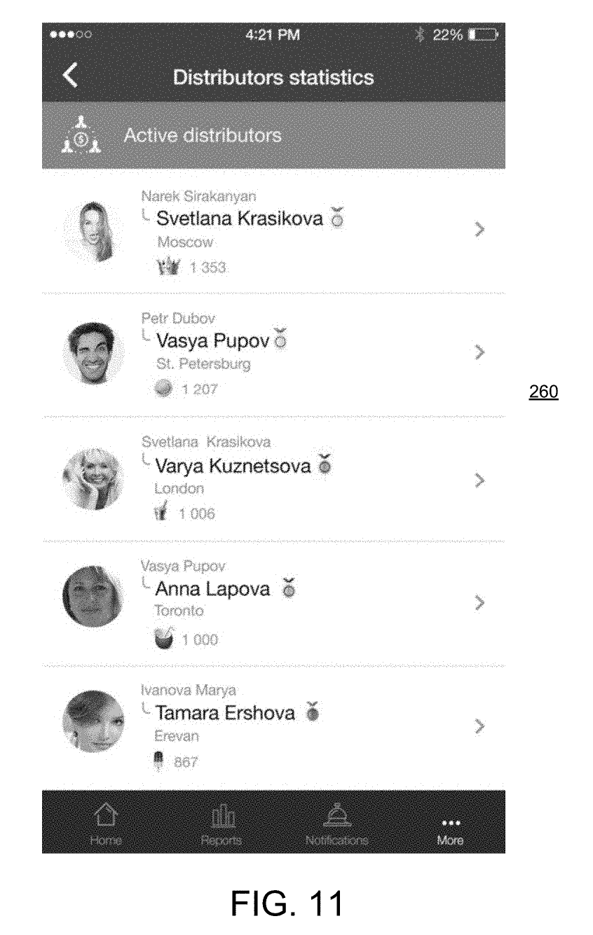

Ranking is displayed in at least two formats: how the distributor ranks within the existing third party MLM and how the distributor ranks amongst other distributors in other third party MLMs that have signed on with the MLM system 100 service. The ranking may be organized into different levels. Each level may have an achievement or prize associated with it. The ranking system may be used by the MLM system 100 to motivate the distributor to improve performance. The ranking system may also be used in the business valuation. FIG. 11 shows a screenshot of the ranking screen 260 provided by the reporting module of an exemplary distributor app.

The ranking system may also be used within the banking module 134 to help determine a credit rating for the distributor. The MLM system 100 may have its own banking institution or the MLM system 100 may partner with an existing banking institution. The banking module 134 can determine a credit score for the distributor based on the ranking system, the business valuation, the distributor's performance within the MLM system 100 or the third party MLM 104. This credit score ban be used by the distributor to obtain loans from the banking institution that is associated with the MLM system 100.

Referring back to FIG. 4, once distributor ranking is determined, the MLM system 100 automatically schedules tasks for the distributor to perform in step 177 through the task scheduling module 126. As mentioned, during the registration step 172, the distributor is asked to set a financial goal. Based on this goal and the profile information supplied by the distributor and/or the third party MLM 104, the task scheduling module 126 automatically creates tasks for the distributor to complete within a certain time frame. The task scheduling module 126 may access and edit the distributor device's 114 native calendar application and populate the calendar with these tasks. The task scheduling module 126 may also set notifications for reminders to complete the tasks via the notification module 138. Upon completion of these scheduled tasks, distributor may receive compensation in the form of points that increase the distributor ranking through the reporting module 124. If the tasks are not completed within the time frame set by the scheduling module 126, points may be deducted from the distributor ranking through the reporting module 124. These scheduled tasks may include, but are not limited to, attending seminars through the education module 130, making calls to contacts, reviewing live calls or recorded calls of downstream distributors, reviewing the distributor's own recorded calls, buying new leads, assigning challenges to downline distributors, or posting to the in-app social network associated with the newsfeed module 136. Tasks are automatically tracked by the task scheduling module and only marked as completed when the task has been performed. Thus, a distributor who has been assigned a task by the task scheduling module 126 cannot simply check that the task has been completed.

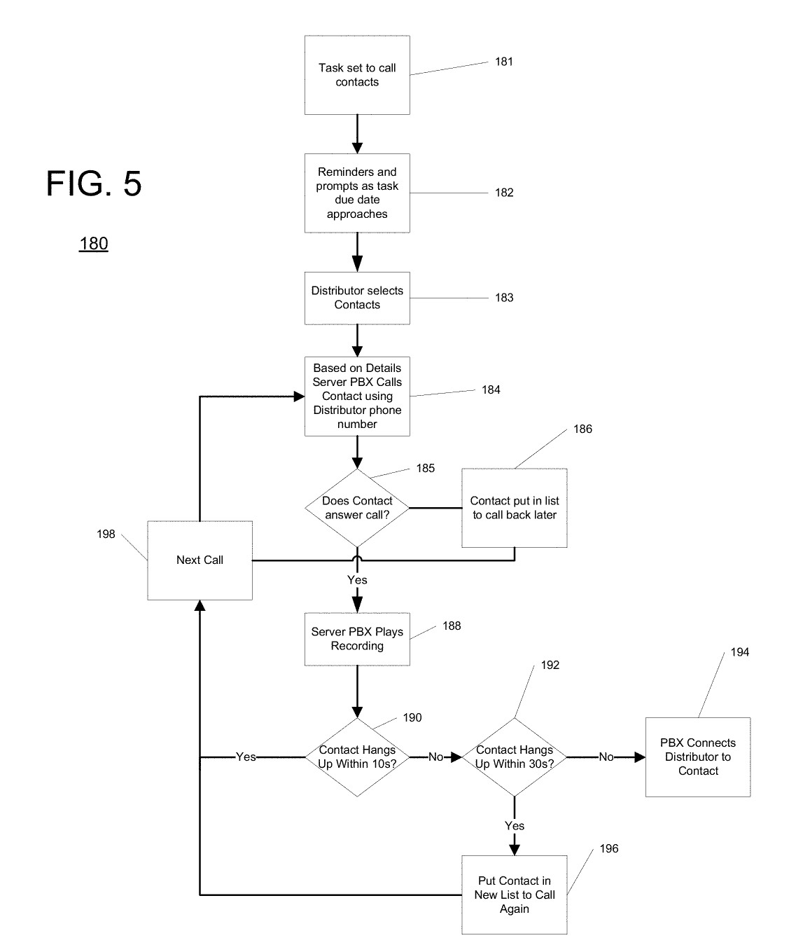

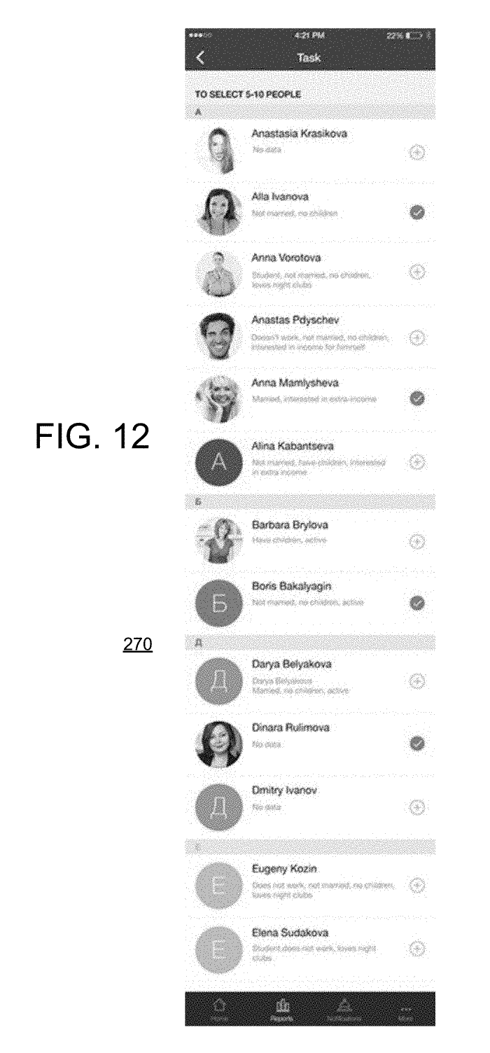

An example of a scheduled task that is created by the task scheduling module 126 is shown in FIG. 5 and is generally referenced by the number 180. In this example, the task scheduling module 126 creates the task for the distributor to call a certain number of contacts in step 181 for a specific time on a specific date. FIG. 12 shows a screenshot of an example of a task screen 270 for an exemplary distributor app. In this screenshot, the distributor is tasked with selecting contacts to call.

Returning to FIG. 5, the task scheduling module 126 may populate the distributor device's 114 native calendar with this task. In step 182, the task scheduling module 126 prompts with reminders for the distributor to select contacts from the contacts module 132 or the task scheduling module 126 automatically chooses contacts based on their contact details.

The contacts module 132 may be automatically populated upon registration by relevant contacts and contact details via the distributor device's 114 native contact list, or may have been populated manually by the distributor.

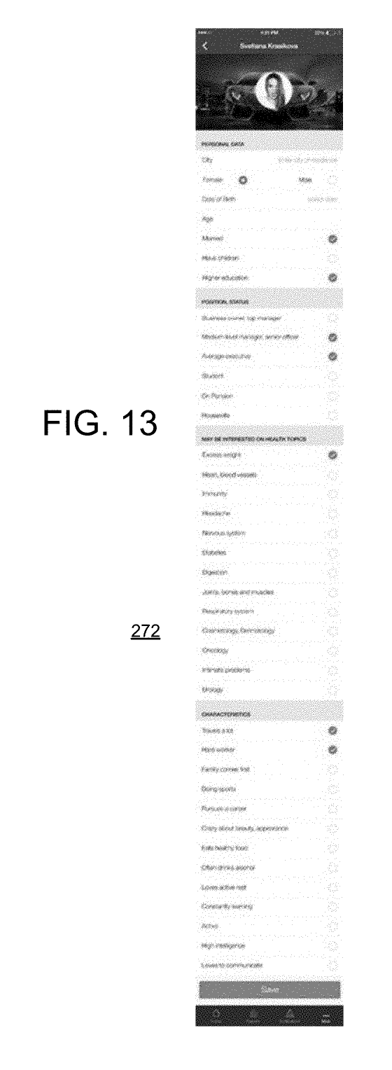

In step 183, the distributor makes a selection of contacts. In step 184, based on the details of the contacts, the MLM server 102, chooses which contacts to call first through a private branch exchange (PBX) (not shown) using the phone number of the distributor device 114. If relevant details about the contacts are missing, the distributor may be prompted to fill these details in before any calls are made. FIG. 13 shows a screenshot of an exemplary task screen 272 where the distributor is being prompted to fill in the details for a contact.

Because the PBX uses the distributor's phone number to make the calls, there is a greater likelihood that the contact will answer the call since it is a phone number that the contact will recognize rather than a random phone number from a telemarketer. There is also a greater likelihood that distributors will not be anxious to call their contact lists since the initial call is coming from the PBX rather than from the distributor.

Returning to FIG. 5, in step 185, the PBX determines if the contact has answered the call. If the contact answers the call, then in step 188, the PBX plays a recording to the contact to introduce the product to be sold and gauge the contact interest. In step 190, the call is being timed to determine if the contact hangs up within 10 seconds. If the contact does not hang up within 30 seconds (step 192), then, in step 194, the PBX calls the distributor on the distributor device 114 to connect the distributor to the contact.

If in step 190, the contact does hang up within 10 seconds, then in step 198, the server determines that the contact is not interested in any offers and the PBX calls the next contact that was selected by the distributor 182. The task scheduling module 126 may automatically create a new task by adding this contact to a new list to be called at a later time with a different recording offering a different product.

If in step 192, the contact does hang up within 30 seconds, the server determines that the contact may have some interest in other offers, and in step 196, puts the contact on a different call list to call for other products. The task scheduling module 126 may automatically create a new task by adding this contact to a new list to be called at a later time with a different recording offering a different product. The method then goes to step 198 where the PBX calls the next contact that was selected by the distributor in step 182.

If the contact does not answer the call in step 184, then in step 186, the call is disconnected and the contact is added back into the list of contacts to be called. The method then moves to step 198 and the PBX places a call to the next contact. After the scheduled calls, the task scheduling module 126 may prompt the distributor to fill out a questionnaire about the call. This questionnaire may be in the form of multiple choice questions. Based on the results of the questionnaire, the contact will be put back into a call list for the distributor to continue working with the contact with other products or to recruit the contact to become a downline distributor.

All tasks assigned by the task scheduling module 126 have an expiry. Assignment of future tasks and their associated expiry time are based on an assessment of whether the distributor finishes currently assigned tasks on time, takes too long to finish a currently assigned task or ignores a currently assigned task altogether.

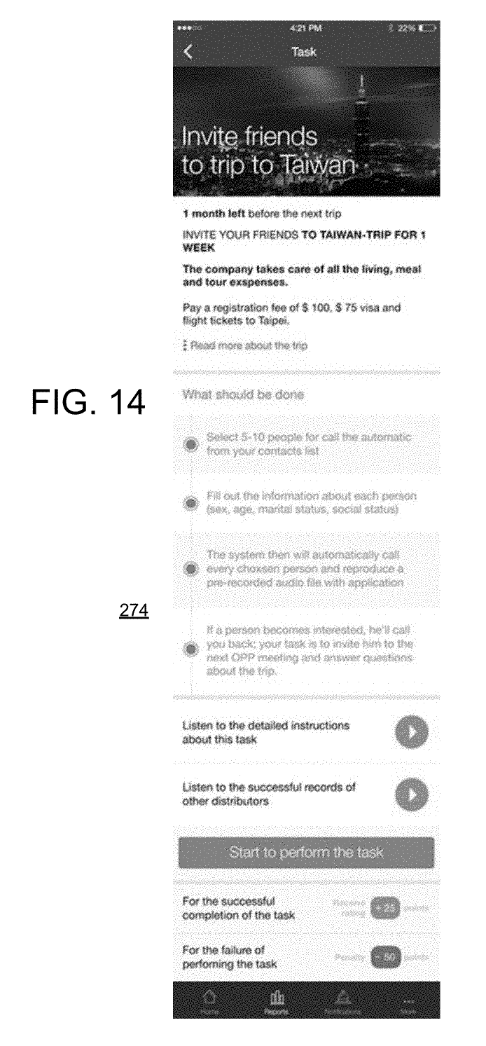

FIG. 14 shows a screenshot of another example of a task screen 274 for an exemplary distributor app. In this screenshot, the distributor is tasked with inviting contacts to a trip.

Returning to FIG. 4, after scheduled tasks are completed, in step 178, the reporting module 124 updates the business valuation and the ranking. The process becomes iterative and returns to step 177 and the task scheduling module 126 schedules more tasks, leading to an automatic and constant updating of business valuation and ranking in real-time.

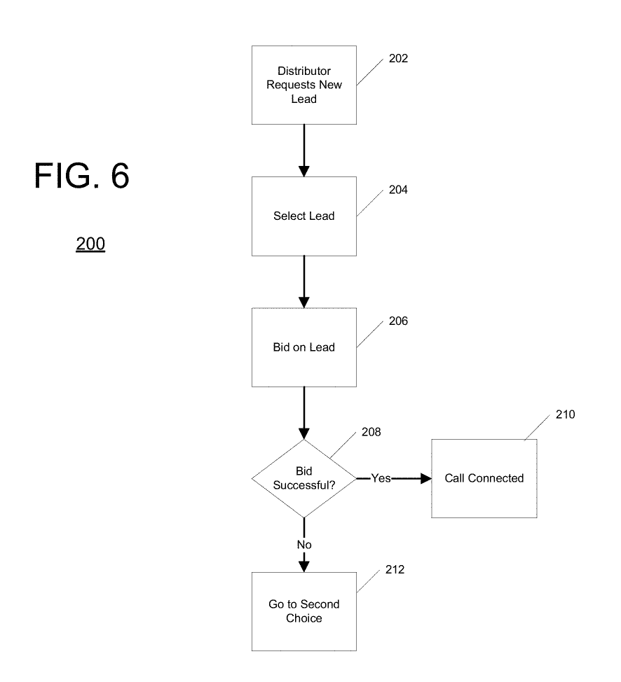

As in any MLM business, recruiting new leads is essential. In an embodiment of the MLM system 100, distributors are able to auction for new leads through the lead recruiting module 128. FIG. 6 is a flow diagram describing the process for the lead recruitment module 128 and is generally referenced by the number 200. In step 202, the distributor requests a new lead by opening the lead recruiting module 128 in the distributor app 120. In step 204, the distributor selects a lead. Leads may be acquired via social media, or by the leads visiting landing pages where they leave their phone numbers. Leads may also be acquired from MLM associations (such as, for example, Direct Selling Association, Multi-level Marketing International Association, Association of Experts of Network Marketing etc.), Career Associations, from events held by the third party MLM, or from marketing campaigns, etc. Leads may also be acquired from any customer who has bought a product from the third party MLM but is not a current contact. The distributor is able to view where the leads come from and can select the leads based on the source of the lead. In step 204, the distributor may select a plurality of leads and rank the selections according to which leads the distributor would most like to win. In step 206, the distributor places a bid on the desired lead. Bids are based on a price the distributor is willing to pay for the lead. The pricing for the leads is not fixed and the prices will change based on supply and demand. In step 208, the lead recruiting module 128 determines if the distributor's bid is successful. If the bid is successful, then in step 210 the PBX connects the call between the distributor and the lead immediately upon winning the bid. Since the distributor has bid on this lead and knows the source of the lead, the distributor is aware of the lead's interests and is better able to speak about the product in terms of the lead's interest. In one embodiment, the distributor may only have 10 seconds to answer the call to connect with the lead. If the distributor does not answer the call, then the lead will go to the next available distributor or the next highest bidding distributor. This ensures that the lead will remain interested or stay warm. If the distributor's bid in step 208 is not successful, in step 212, the distributor may be awarded the second or third choice of lead depending on the price of the lead.

During any phone call, whether it is assigned by the task scheduling module 126 or obtained through the lead recruiting module 128, a distributor may play a recording or a podcast in order to answer contact or lead questions. This frees the distributor from reading any scripts and allows the distributor and the contact or lead to discuss the answer provided by the recording or podcast.

All phone calls and text messages (SMS) through the PBX are charged to, and paid for, by the distributor. The system may charge a pre-paid fee for a certain number of minutes for phone calls or a certain number of SMS through the PBX. The system may offer different fee plans for different numbers of minutes or SMS.

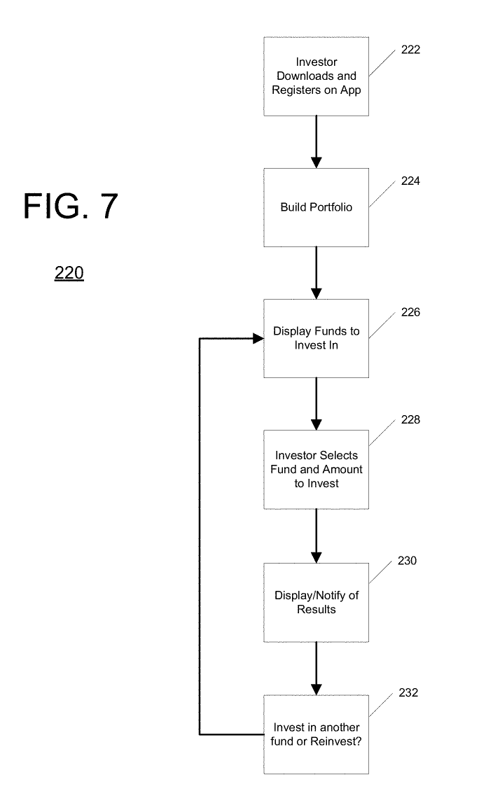

The MLM system 100 allows for investors to invest in the MLM system 100 through the investor app 150 of FIG. 3. FIG. 7 is a flow diagram describing the process for an investor to begin investing in the MLM system 100 and is generally referenced by the number 220. At step 222, an investor downloads the investor app 150 to the investor device 116 and registers with the MLM system 100 via the investor app 150. The investor app 150 may be downloaded from any mobile app store including, but not limited to, the Apple App store, the Android Play store, the BlackBerry World, etc.

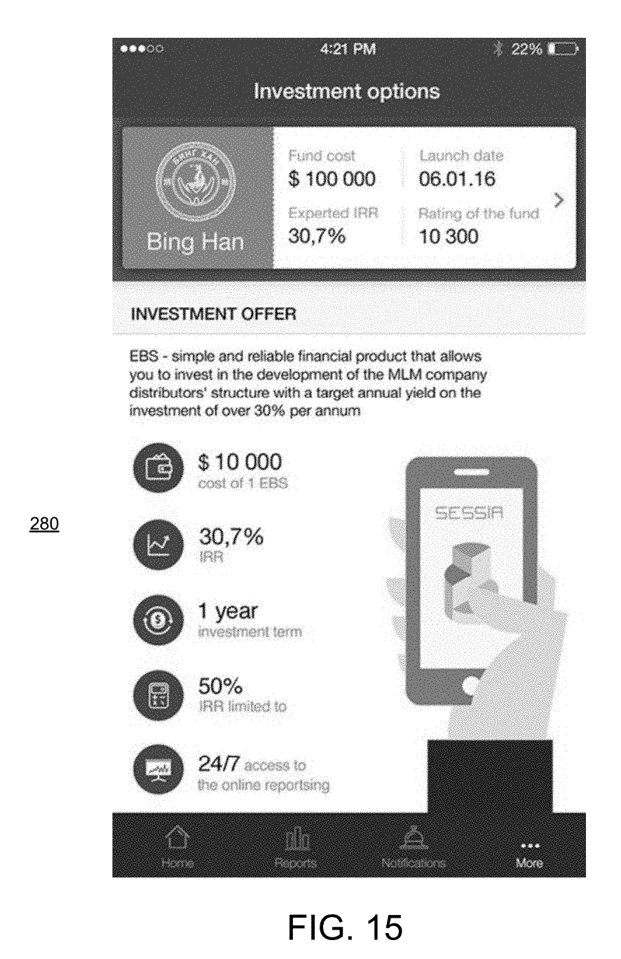

In step 224, the investor app 150 builds the investor portfolio using the investor reporting module 156. The investor profile and portfolio are based on the amount of money the investor has to invest and the funds that the investor buys. The investing module 154 displays funds for the investor to invest in. Funds may be based on company. For example, a certain company may have a fund associated with it. A certain number of distributors within that company will belong to that fund. In one embodiment, the top rated distributors using the mobile distributor app 120 participate in the fund for their company. Therefore, if an investor selects a fund in step 228 and invests money into a fund, then leads will be generated for the distributors in the fund without requiring the distributors to pay for the leads through the lead recruiting module. Alternatively, the money the investor invests can go to paying for phone call minutes for distributors in that fund. In step 230, the reporting module displays the performance results of the fund at regular intervals. The results are calculated based on the sales activity of each distributor within the fund. The results may be displayed graphically. Investors' returns on their investments may be paid at regular intervals such as quarterly. The task scheduling module 126 of the distributor app 120 of a distributor within a fund may be configured to set tasks in order to meet the fund's expected returns. An investor can buy into an unlimited number of funds as seen in step 232. Alternatively, an investor will also be given the option of reinvesting the returns from a fund once the returns are received. All relevant investor information and data for the investor app 150 are stored on the investor database 108. FIG. 15 shows a screenshot of an opening screen 280 for an exemplary investor app.

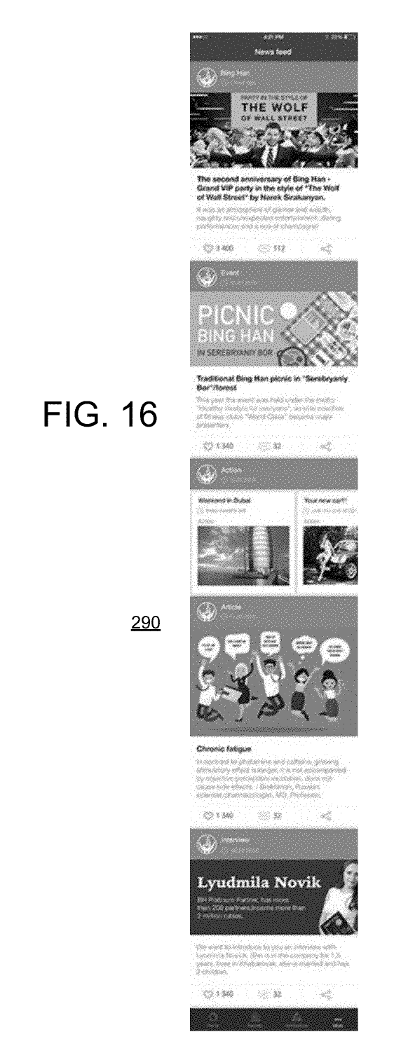

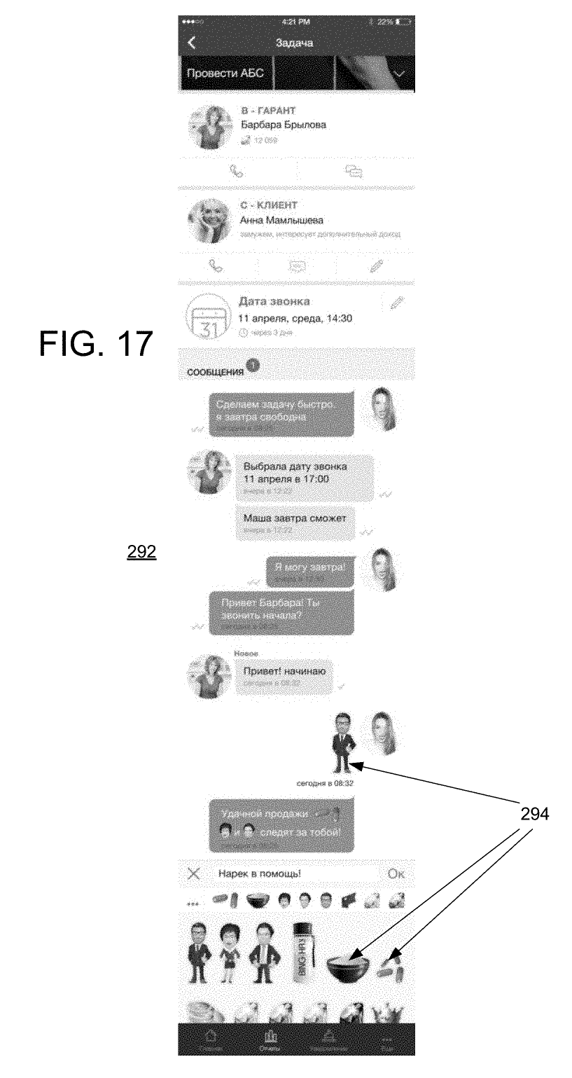

The distributor app 120 and the investor app 150 may include a news feed 136 (not shown in FIG. 3) that provides posts from the third party MLM 104, the MLM system 100, or other social networks. Third party MLMs, distributors, and investors may be able to make posts or to comment on posts. The reporting module 124 may modify the ranking of a distributor who makes a post with many ‘likes’, ‘shares’, or comments. FIG. 16 shows a screenshot of one embodiment of the newsfeed screen 290 for an exemplary distributor app. FIG. 17 shows a screenshot for another embodiment of the newsfeed screen 292 for an exemplary distributor app. In this embodiment, the distributor is able to add specialty badges 294 to the comments, posts, icons, or avatars. The specialty badges may represent, but are not limited to, representing a brand, product, or company.

It should be understood that the MLM system 100 and distributor app 120 provided herein may also be applied to direct selling companies. The processes undertaken by the system 100 would work in the same manner, however, there would be only one tier of distributors, that is, there would not be the levels of upline and downline distributors.

The methods and processes described above may be embodied in, and fully automated via, software code modules executed by one or more general purpose computers or processors, including mobile phones. The code modules may be stored in any type of computer-readable medium or other computer storage device. Some or all of the methods may alternatively be embodied in specialized computer hardware. Further, components and tasks described herein can be implemented as web services. Data described herein as being received or generated by a computer system may optionally be stored in and accessed from computer readable memory.

The computers described herein (including servers, devices, smartphones, etc.) can include one or more central processing units (CPUs) that execute program code and process data, memory, including volatile memory, such as random access memory (RAM) optionally for temporarily storing data and data structures during program execution, and/or non-volatile memory, such as a hard disc drive, optical drive, or FLASH drive, optionally for storing programs and data, including databases, and a wired and/or wireless network interface for accessing an intranet and/or Internet. The computers can include a display for displaying user interfaces, data, and the like, and one or more user input devices, such as a keyboard, mouse, pointing device, microphone and/or the like, used to navigate, provide commands, enter information, provide search queries, and/or the like.

It should be understood that the phrase “a” or “an” used in conjunction with the Applicant's teachings with reference to various elements encompasses “one or more” or “at least one” unless the context clearly indicates otherwise. Additionally, conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

While the Applicant's teachings have been particularly shown and described with reference to specific illustrative embodiments, it should be understood that various changes in form and detail may be made without departing from the scope of the teachings. Therefore, all embodiments that come within the scope of the teachings, and equivalents thereto, are claimed. The descriptions and diagrams of the methods of the Applicant's teachings should not be read as limited to the described order of elements unless stated to that effect.

While the Applicant's teachings have been described in conjunction with various embodiments and examples, it is not intended that the Applicant's teachings be limited to such embodiments or examples. On the contrary, the Applicant's teachings encompass various alternatives, modifications, and equivalents, as will be appreciated by those of skill in the art, and all such modifications or variations are believed to be within the sphere and scope of the invention.

What is claimed is:

1. A system for managing a hierarchy of a plurality of distributors over a computer network comprising:
a server in communication with at least one third party marketing server and at least one distributor database; and
a plurality of distributor devices communicating over the computer network with the server, the plurality of distributor devices each operating a distributor mobile application, the distributor mobile application configured to determine a business value for each of the plurality of distributors based on the business information provided by the at least one third party marketing server,
wherein the business value is updated on the at least one distributor database via the server over the computer network.

2. The system of claim 1, further comprising:
an investor database storing investor information related to at least one investor and a plurality of funds based on the hierarchy of the plurality of distributors; and
at least one investor device communicating over the computer network with the server, the at least one investor devices operating an investor mobile application, the investor mobile application configured to present the plurality of funds from which an investor selects to purchase,
wherein the server updates the investor information and the plurality of funds based on the investor purchase.

3. The system of claim 1, wherein the distributor mobile application further configured to determine a ranking for each of the plurality of distributors, each ranking determined based on tasks performed by each distributor through the distributor mobile application.

4. The system of claim 3, wherein tasks are selected from the group consisting of phoning a contact, watching a seminar, reviewing recordings of phone calls, and buying new leads.

5. The system of claim 1, wherein the business information comprises discounted cash flow models, business structure analysis, projected cash flow and discounts.

6. The system of claim 3, wherein the ranking is utilized to determine business value.

7. The system of claim 1 wherein the ranking is used to determine a credit rating to be utilized by a banking institution.

8. A method of routing a phone call to a lead in a sales network comprising:
acquiring a lead phone number associated with the lead;
initiating a phone call to the lead using the lead phone number, the call initiated by a sales network server;
auctioning the phone call to a plurality of distributors over the sales network, wherein the plurality of distributors place bids to win the phone call;
determining a first winning bid by a first winning distributor from the plurality of bids by the plurality of distributors; and
connecting the phone call between the lead and the first winning distributor,
wherein the sales network server calls the first winning distributor to connect the phone call with the lead.

9. The method of claim 8 further comprising:
determining whether the phone call has been answered by the first winning distributor;
when it is determined that the phone call is unanswered by the first winning distributor, determining a second winning bid by a second winning distributor from the plurality of bids by the plurality of distributors; and
connecting the phone call between the lead and the second winning distributor.

10. A method of scheduling communication between a distributor and at least one contact on a distributor mobile application on a distributor device connected to a sales network, the method comprising:
prompting the distributor to select at least one contact through the distributor mobile application;
prompting the distributor to enter relevant details about the at least one contact through the distributor mobile application;
upon receiving the relevant details about the at least one contact, initiating a first phone call via the sales network to the at least one contact;
upon the at least one contact answering the first phone call, playing a recording to the at least one contact;
determining whether the at least one contact remains on the first phone call after a predetermined amount of time;
upon determining that the at least one contact remains on the first phone call after a predetermined amount of time, initiating a second phone call via the server and the distributor device; and
upon the distributor answering the second phone call, connecting the first phone call with the second phone call.

11. The method of claim 10 further comprising prompting the distributor to fill out a questionnaire based on the communication between the contact and the distributor.

12. The method of claim 10, wherein after the step of determining whether the at least one contact remains on the first phone call, upon determining that the at least one contact does not remain on the phone call, terminating the first phone call and placing the at least one contact into a call back list.

13. The method of claim 12, wherein after terminating the first phone call, initiating a third phone call with a new at least one contact.

14. The method of claim 10, wherein the predetermined amount of time is about 10 seconds.

15. The method of claim 14, wherein the predetermined amount of time is about 30 seconds.

16. The method of claim 9, wherein the server initiates the first and second phone calls through a private branch exchange.

17. A method of initializing a distributor to utilize a distributor mobile application with a sales server over a computer network comprising steps of:
registering the distributor mobile application on the sales server, the sales server automatically requesting distributor information from a third party server to register the distributor;
determining a business value for the distributor based on the requested distributor information;
determining a ranking for the distributor based on the requested distributor information and a record of completed tasks by the distributor;
scheduling tasks to be performed by the distributor at a predetermined time, the scheduled tasks assessed by the distributor mobile application for completion;
upon completion of the scheduled tasks, determining a new business value and a new ranking; and
updating a database in communication with the server with the new business value and the new ranking.

18. The system of claim 16, wherein tasks are selected from the group consisting of phoning a contact, watching a seminar, reviewing recordings of phone calls, and buying new leads.

19. A method of providing investment by an investor to a plurality of distributors comprising:
presenting a plurality of funds to the investor on an investor mobile application on an investor device, the plurality of funds each representing a plurality of distributors;
prompting the investor to select one of the plurality of funds for purchase;
upon selecting one of the plurality of funds, transferring a monetary value based on the purchase to the plurality of distributors as an investment; and
displaying and returning results of the investment on the investor device through the investor mobile application.
